(19) United States
(12) Patent Application Publication
(10) Pub. No.: US 2017/0091805 A1
(43) Pub. Date: Mar. 30, 2017

(54) Advertisement Recommendation Method and Advertisement Recommendation Server

(71) Applicant: Huawei Technologies Co., Ltd., Shenzhen (CN)

(72) Inventors: Dandan Tu, Shenzhen (CN); Yong Zhang, Hangzhou (CN)

(21) Appl. No.: 15/378,311

(22) Filed: Dec. 14, 2016

Related U.S. Application Data
(63) Continuation of application No. PCT/CN2015/072573, filed on Feb. 9, 2015.

(30) Foreign Application Priority Data
Jun. 16, 2014 (CN) 201410268560.5

(51) Int. Cl. G06Q 30/02

(52) U.S. Cl. CPC G06Q 30/0244; G06Q 30/0255; G06Q 30/0277

(57) ABSTRACT

An advertisement recommendation method and an advertisement recommendation server. The method includes: acquiring webpage visit information and advertisement click information; predicting, according to the webpage visit information and the advertisement click information, probabilities of clicking x advertisements when the ith user among m users visits the jth webpage; determining a novelty factor corresponding to each respective advertisement of the x advertisements; and determining, from the x advertisements according to the probabilities of clicking the x advertisements and the novelty factor corresponding to the respective advertisement, p advertisements to be recommended to the ith user.

### CROSS-REFERENCE TO RELATED APPLICATIONS

This application is a continuation of international patent application number PCT/CN2015/072573 filed on Feb. 9, 2015, which claims priority to Chinese patent application number 201410268560.5 filed on Jun. 16, 2014, which are incorporated by reference.

### TECHNICAL FIELD

The present disclosure relates to the information processing field, and specifically, to an advertisement recommendation method and an advertisement recommendation server.

### BACKGROUND

An Internet online advertisement has become a main advertising manner in addition to television and newspaper. The online advertisement revenue is closely correlated with a click-through rate of an advertisement, and increasing the click-through rate of the advertisement is one of the effective ways of increasing the advertisement revenue. To improve the click-through rate of the advertisement, it is necessary to predict a clicking probability of the advertisement by a user before recommending the advertisement.

Currently, two algorithms are mainly used to predict a clicking probability of an advertisement, to recommend the advertisement to the user. One is a content-based filtering (CBF) recommendation algorithm, and the other is a user-based or item-based collaborative filtering (CF) recommendation algorithm.

Specifically, with regard to the CBF algorithm, an advertisement is recommended to a target user using an information retrieval technology or an information filtering technology and according to a correlation between an advertisement and webpage content. In other words, an advertisement with a higher correlation to webpage content is considered to have a higher clicking probability. Therefore, on a same webpage, a same advertisement is usually recommended to the user. However, such an algorithm does not consider an interest of the user, which causes low accuracy of predicting a clicking probability of an advertisement. As a result, it is difficult to ensure a click-through rate of the advertisement.

With regard to the user-based CF algorithm, a similarity between users is calculated mainly according to historical advertisement click information of the users, a degree of preference of a target user on an advertisement is predicted according to a situation of clicking the advertisement by a user who has a higher similarity to the target user, and the advertisement is recommended to the target user according to the degree of preference. With regard to the item-based CF algorithm, an advertisement set most similar to a target advertisement is selected mainly by calculating a similarity between advertisements, and it is determined, according to a degree of preference of a current user on a most similar advertisement, whether to recommend the target advertisement. These two CF algorithms predict a clicking probability of an advertisement by using a preference degree of a user. Therefore, compared with the CBF algorithm, the CF algorithm improves, to an extent, accuracy of predicting a clicking probability of an advertisement, and can improve a click-through rate of an advertisement. However, because a user often visits webpages of similar content, an advertisement recommended to the user by using the CF algorithm is usually similar to an advertisement that is familiar to the user, and an advertisement that the user is unfamiliar with and potentially interested in cannot be discovered, thereby causing a low click-through rate of an advertisement, and poor user experience.

### SUMMARY

Embodiments of the present disclosure provide an advertisement recommendation method and an advertisement recommendation server, which can improve a click-through rate of an advertisement and further improve user experience.

According to a first aspect, an advertisement recommendation method is provided, including: acquiring, from a user Internet visit log, webpage visit information and advertisement click information, where the webpage visit information is used to indicate n webpages visited by m users, the advertisement click information is used to indicate x advertisements clicked by the m users on the n webpages, and n, m and x are all positive integers greater than 1; predicting, according to the webpage, visit information and the advertisement click information, probabilities of clicking the x advertisements when the i^{th} user among the m users visits the j^{th} webpage, where i is a positive integer ranging from 1 to m, and j is a positive integer ranging from 1 to n; determining a novelty factor corresponding to each respective advertisement of the x advertisements, where a novelty factor corresponding to each respective advertisement of the x advertisements is used to represent a degree of awareness of the i^{th} user about each advertisement; and determining, from the x advertisements according to the probabilities of clicking the x advertisements and the novelty factor corresponding to each respective advertisement of the x advertisements, p advertisements to be recommended to the i^{th} user, where a degree of awareness of the i^{th} user about the p advertisements is lower than a degree of awareness of the ith user about an advertisement other than the p advertisements in the x advertisements, and a sum of probabilities of clicking the p advertisements are higher than a sum of probabilities of clicking an advertisement other than the p advertisements in the x advertisements, where p is a positive integer and p≦x.

With reference to the first aspect, in a first possible implementation manner, the determining the novelty factor corresponding to each respective advertisement of the x advertisements includes: determining, according to historical recommendation information, the novelty factor corresponding to each respective advertisement of the x advertisements, where the historical recommendation information is used to indicate a historical record of recommending the x advertisements separately to the i^{th} user.

With reference to the first possible implementation manner of the first aspect, in a second possible implementation manner, the determining, according to historical recommendation information, the novelty factor corresponding to each respective advertisement of the x advertisements includes: for the k^{th} advertisement in the x advertisements, if the historical recommendation information indicates that the k^{th} advertisement has not been recommended to the i^{th} user, determining that a novelty factor corresponding to the k^{th} advertisement is a first value; and if the historical recommendation information indicates that the k^{th} advertisement has been recommended to the i^{th} user before, determining that the novelty factor corresponding to the k^{th} advertisement is a second value; where the first value is greater than the second value, and k is a positive integer ranging from 1 to x.

With reference to the second possible implementation manner of the first aspect, in a third possible implementation manner, the determining that the novelty factor corresponding to the k^{th} advertisement is a second value includes: determining that the k^{th} advertisement was recommended to the i^{th} user q days ago, where q is a positive integer; determining an Ebbinghaus forgetting curve value that is corresponding to the q days; and determining that the novelty factor corresponding to the k^{th} advertisement is a difference between the first value and the Ebbinghaus forgetting curve value.

With reference to the first aspect, in a fourth possible implementation manner, the determining the novelty factor corresponding to each respective advertisement of the x advertisements includes: for the k^{th} advertisement in the x advertisements, determining a similarity between the k^{th} advertisement and another advertisement in the x advertisements; determining, in the x advertisements according to the similarity between the k^{th} advertisement and the another advertisement, a similarity ranking corresponding to the k^{th} advertisement and a dissimilarity ranking corresponding to the k^{th} advertisement; and performing weighing on the similarity ranking corresponding to the k^{th} advertisement and the dissimilarity ranking corresponding to the k^{th} advertisement to obtain a novelty factor corresponding to the k^{th} advertisement, where k is a positive integer ranging from 1 to x.

With reference to the first aspect, in a fifth possible implementation manner, the determining the novelty factor corresponding to each respective advertisement of the x advertisements includes: for the k^{th} advertisement in the x advertisements, determining a diversity distance between the k^{th} advertisement and another advertisement in the x advertisements; and determining, according to the diversity distance between the k^{th} advertisement and the another advertisement, a novelty factor corresponding to the k^{th} advertisement; where k is a positive integer ranging from 1 to x.

With reference to the first aspect or any one of the foregoing implementation manners, in a sixth possible implementation manner, the determining, from the x advertisements according to the clicking probabilities corresponding to each respective advertisement of the x advertisements and the novelty factor corresponding to each respective advertisement of the x advertisements, p advertisements to be recommended to the i^{th} user includes: performing weighing on a clicking probability corresponding to each respective advertisement of the x advertisements and the novelty factor corresponding to each respective advertisement of the x advertisements, to determine scores corresponding to each respective advertisement of the x advertisements; sorting, in descending order of the scores corresponding to the x advertisements, the x advertisements to obtain x sorted advertisements; and determining the first p advertisements in the x sorted advertisements as the p advertisements to be recommended to the i^{th} user.

With reference to the first aspect or any one of the first possible implementation manner to the fifth possible implementation manner, in a seventh possible implementation manner, the determining, from the x advertisements according to the clicking probabilities corresponding to each respective advertisement of the x advertisements and the novelty factor corresponding to each respective advertisement of the x advertisements, p advertisements to be recommended to the i^{th} user includes: sorting, in descending order of the clicking probabilities, the x advertisements to obtain x sorted advertisements; sorting, in descending order of the novelty factors, the first q advertisements in the x sorted advertisements to obtain q re-sorted advertisements, where q is a positive integer and q is greater than p; and determining the first p advertisements in the q re-sorted advertisements as the p advertisements to be recommended to the i^{th} user.

With reference to the first aspect or any one of the foregoing implementation manners, in an eighth possible implementation manner, the predicting, according to the webpage visit information and the advertisement click information, probabilities of clicking the x advertisements when the i^{th} user among the m users visits the j^{th} webpage includes: generating, according to the webpage visit information and the advertisement click information, a user-webpage visit matrix, a user-advertisement click matrix, and an advertisement-webpage association matrix, where an object in the i^{th} row and the j^{th} column of the user-webpage visit matrix represents a record of visits to the j^{th} webpage by the i^{th} user, an object in the i^{th} row and the k^{th} column of the user-advertisement click matrix represents a record of clicks on the k^{th} advertisement by the i^{th} user, and an object in the j^{th} row and the k^{th} column of the advertisement-webpage association matrix represents a degree of an association between the j^{th} webpage and the k^{th} advertisement, where k is a positive integer ranging from 1 to x; performing unified probabilistic matrix factorization on the user-webpage visit matrix, the user-advertisement click matrix, and the advertisement-webpage association matrix, to obtain a user implicit feature vector of the i^{th} user, a webpage implicit feature vector of the j^{th} webpage, and an advertisement implicit feature vector of the k^{th} advertisement; and determining, according to the user implicit feature vector of the i^{th} user, the webpage implicit feature vector of the j^{th} webpage, and the advertisement implicit feature vector of the k^{th} advertisement, a probability of clicking the k^{th} advertisement when the i^{th} user visits the j^{th} webpage.

According to a second aspect, an advertisement recommendation server is provided, including hardware and/or software components to perform the steps included in any one of the foregoing implementation manners of the first aspect.

In the embodiments of the present disclosure, probabilities of clicking x advertisements when the i^{th} user visits the j^{th} webpage are predicted according to webpage visit information and advertisement click information, a novelty factor corresponding to each respective advertisement of the x advertisements are determined according to historical recommendation information, and p advertisements to be recommended to the i^{th} user are determined from the x advertisements according to the probabilities of clicking the x advertisements and the novelty factor corresponding to each respective advertisement of the x advertisements, where a degree of awareness of the i^{th} user about the p advertisements is lower than a degree of awareness of the i^{th} user about an advertisement other than the p advertisements, in the x advertisements, and a sum of probabilities of clicking the p advertisements are higher than a sum of probabilities of clicking an advertisement other than the p advertisements, in the x advertisements. Because a probability of clicking an advertisement is predicted by comprehensively considering information about a user, a webpage, and an advertisement, accuracy of predicting a probability of clicking an advertisement can be improved. In addition, because novelty of an advertisement is considered, recommending a same type of advertisement to a user in a long time without considering a potential interest of the user can be avoid. Therefore, a click-through rate of an advertisement can be improved, and user experience is further improved.

### BRIEF DESCRIPTION OF DRAWINGS

To describe the technical solutions in the embodiments of the present disclosure more clearly, the following briefly introduces the accompanying drawings required for describing the embodiments of the present disclosure. The accompanying drawings in the following description show merely some embodiments of the present disclosure, and a person of ordinary skill in the art may still derive other drawings from these accompanying drawings without creative efforts.

FIG. 1 is a schematic flowchart of an advertisement recommendation method according to an embodiment of the present disclosure;

FIG. 2 is a schematic flowchart of a process of an advertisement recommendation method according to an embodiment of the present disclosure;

FIG. 3 is a schematic diagram of an AdRec model according to an embodiment of the present disclosure;

FIG. 4 is a schematic block diagram of an advertisement recommendation server according to an embodiment of the present disclosure;

FIG. 5 is a schematic block diagram of an advertisement recommendation server according to an embodiment of the present disclosure; and

FIG. 6 is a schematic block diagram of an advertisement recommendation system according to an embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are a part rather than all of the embodiments of the present disclosure.

The embodiments of the present disclosure may be applied in scenarios of object recommendation, for example, a recommendation of a commodity, an application, or a song. Therefore, in the embodiments of the present disclosure, an advertisement may be a carrier of these recommendation objects, and information about a recommended object may be displayed by using an advertisement page.

A method provided by the embodiments of the present disclosure may be performed by an advertisement recommendation server. The advertisement recommendation server may store an advertisement published by an advertiser, manage the advertisement published by the advertiser, and provide an advertisement service to a user. Specifically, the advertisement recommendation server may collect statistics on information, such as a record of clicks on an advertisement by the user and a record of clicks on a webpage by the user, and may recommend an advertisement to the user based on such information.

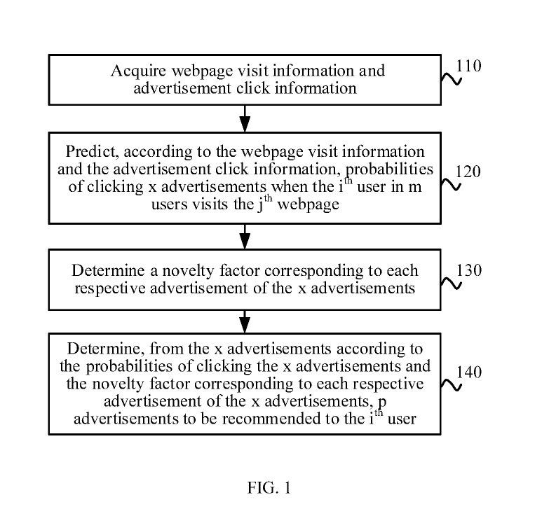

FIG. 1 is a schematic flowchart of an advertisement recommendation method according to an embodiment of the present disclosure. The method in FIG. 1 may be performed by an advertisement recommendation server.

110. Acquire, from a user Internet visit log, webpage visit information and advertisement click information, where the webpage visit information is used to indicate n webpages visited by m users, the advertisement click information is used to indicate x advertisements clicked by the m users on the n webpages, and n, m and x are all positive integers greater than 1.

120. Predict, according to the webpage visit information and the advertisement click information, probabilities of clicking the x advertisements when the i^{th} user among the m users visits the j^{th} webpage, where i is a positive integer ranging from 1 to m, and j is a positive integer ranging from 1 to n.

130. Determine, according to historical recommendation information, the novelty factor corresponding to each respective advertisement of the x advertisements, where the historical recommendation information is used to indicate a historical record of recommending the x advertisements separately to the i^{th} user, and a novelty factor corresponding to each respective advertisement of the x advertisements is used to represent a degree of awareness of the i^{th} user about the advertisement.

140. Determine, from the x advertisements according to the probabilities of clicking the x advertisements and the novelty factor corresponding to each respective advertisement of the x advertisements, p advertisements to be recommended to the i^{th} user, where a degree of awareness of the i^{th} user about the p advertisements is lower than a degree of awareness of the i^{th} user about an advertisement other than the p advertisements in the x advertisements, and a sum of probabilities of clicking the p advertisements are higher than a sum of probabilities of clicking an advertisement other than the p advertisements in the x advertisements, where p is a positive integer and p≦x.

In this embodiment of the present disclosure, probabilities of clicking x advertisements when the i^{th} user visits the j^{th} webpage are predicted according to webpage visit information and advertisement click information, the novelty factor corresponding to each respective advertisement of the x advertisements are determined according to historical recommendation information, and p advertisements to be recommended to the i^{th} user are determined from the x advertisements according to the probabilities of clicking the x advertisements and the novelty factor corresponding to each respective advertisement of the x advertisements, where a degree of awareness of the i^{th} user about the p advertisements is lower than a degree of awareness of the i^{th} user about an advertisement other than the p advertisements, in the x advertisements, and a sum of probabilities of clicking the p advertisements are higher than a sum of probabilities of clicking an advertisement other than the p advertisements in the x advertisements. Because a probability of clicking an advertisement is predicted by comprehensively considering information about a user, a webpage, and an advertisement, accuracy of predicting a probability of clicking an advertisement can be improved. In addition, because novelty of an advertisement is considered, recommending a same type of advertisement to a user in a long time without considering a potential interest of the user can be avoid. Therefore, a click-through rate of an advertisement can be improved, and user experience is further improved.

Specifically, in a current advertisement recommendation algorithm, the probability of clicking an advertisement is predicted by using two-dimensional information, for example, related information of an advertisement and a webpage or related information of a user and an advertisement. In addition, based on a current CBF algorithm or a CF algorithm, an advertisement recommended to a user is similar, in most cases, to an advertisement that is familiar to the user. It is difficult to recommend, to the user, an advertisement that the user is unfamiliar with but potentially interested in.

In this embodiment of the present disclosure, webpage visit information is used to indicate n webpages visited by m users, and advertisement click information is used to indicate x advertisements clicked by the m users on the n webpages; therefore, predicting a probability of clicking an advertisement according to the webpage visit information and the advertisement click information is predicting probabilities of clicking x advertisements by using information about three dimensions, that is, a user, a webpage, and an advertisement, which can improve accuracy of predicting a probability of clicking an advertisement. In addition, novelty factor corresponding to each respective advertisement of the x advertisements are determined according to historical recommendation information that is used to indicate a historical record of the x advertisements recommended to the i^{th} user. In this way, when p advertisements to be recommended to the i^{th} user are determined according to the probabilities of clicking the x advertisements and the novelty factor corresponding to each respective advertisement of the x advertisements, both accuracy of predicting a probability of clicking an advertisement and novelty of an advertisement are considered. Therefore, the accuracy of predicting a probability of clicking an advertisement can be improved; in addition, because the novelty of an advertisement is considered, recommending a same type of advertisement to a user in a long time without considering a potential interest of the user can be avoided, thereby improving a click-through rate of an advertisement and improving user experience.

It should be understood that, in this embodiment of the present disclosure, the i^{th} user may be any user among the m users, and the j^{th} webpage may be any webpage in the n webpages.

Optionally, in an embodiment, the foregoing x advertisements may be all advertisements or some advertisements stored in the advertisement recommendation server.

Optionally, in another embodiment, in step 120, a user-webpage visit matrix, a user-advertisement click matrix, and an advertisement-webpage association matrix may be generated according to the webpage visit information and the advertisement click information, where an object in the i^{th} row and the j^{th} column of the user-webpage visit matrix represents a record of visits to the j^{th} webpage by the i^{th} user, an object in the i^{th} row and the k^{th} column of the user-advertisement click matrix represents a record of clicks on the k^{th} advertisement by the i^{th} user, and an object in the j^{th} row and the k^{th} column of the advertisement-webpage association matrix represents a degree of an association between the j^{th} webpage and the k^{th} advertisement, where k is a positive integer ranging from 1 to x. Then, unified probabilistic matrix factorization may be performed on the user-webpage visit matrix, the user-advertisement click matrix, and the advertisement-webpage association matrix, to obtain a user implicit feature vector of the i^{th} user, a webpage implicit feature vector of the j^{th} webpage, and an advertisement implicit feature vector of the k^{th} advertisement. Finally, a probability of clicking the k^{th} advertisement when the i^{th} user visits the j^{th} webpage may be determined according to the user implicit feature vector of the i^{th} user, the webpage implicit feature vector of the j^{th} webpage, and the advertisement implicit feature vector of the k^{th} advertisement.

Generally, a quantity of webpages is significantly large. After the webpages are classified, the webpage visit information and the advertisement click information may be converted into a user-webpage visit matrix and a user-advertisement click matrix, and a matrix of a probability of clicking an advertisement when a webpage and an advertisement appear at the same time. For example, the webpages may be classified by domain names. In addition, information about a similarity between a webpage and an advertisement may be extracted from the webpage visit information and the advertisement click information. Based on the matrix of a probability of clicking an advertisement when a webpage and an advertisement appear at the same time and the information about a similarity between a webpage and an advertisement, the advertisement-webpage association matrix may be obtained.

Factorization may be performed on the user-webpage visit matrix, the user-advertisement click matrix, and the advertisement-webpage association matrix by using a unified probabilistic matrix factorization (UPMF) algorithm, to obtain the probabilities of clicking the x advertisements when the i^{th} user visits the j^{th} webpage.

The user-webpage visit matrix and the user-advertisement click matrix can reflect an interest of a user, and the advertisement-webpage association matrix can reflect a correlation between a webpage and an advertisement. It may be learned that, in this embodiment, both the interest of the user and the correlation between a webpage and an advertisement are considered to predict probabilities of clicking advertisements. Therefore, accuracy of predicting a probability of clicking an advertisement can be improved, thereby ensuring a click-through rate of an advertisement.

Currently, because a quantity of webpages and a quantity of users are quite large, data of visits to a webpage by a user and data of clicks on an advertisement by a user are quite sparse. This phenomenon may also be referred to as data sparseness. In this case, accuracy of predicting, by using the CBF algorithm or the CF algorithm, a probability of clicking an advertisement is greatly reduced. However, in this embodiment of the present disclosure, a probability of clicking an advertisement is predicted according to the user-webpage visit matrix, the user-advertisement click matrix, and the advertisement-webpage association matrix by using the unified probabilistic matrix factorization algorithm. Although these three matrices may all be sparse matrices, a probability of clicking an advertisement is not predicted based on only one of these matrices, so that the accuracy of predicting a probability of clicking an advertisement may still be ensured in the case of data sparseness. A sparse matrix may refer to a matrix in which a relatively large quantity of row or column data is missing.

Specifically, when the i^{th} user visits the j^{th} webpage, for the k^{th} advertisement in the x advertisements, factorization may be performed on the user-webpage visit matrix, the user-advertisement click matrix, and the advertisement-webpage association matrix by using a unified maximum posteriori probability as a target function and based on a gradient descent method, to obtain the user implicit feature vector of the i^{th} user, the webpage implicit feature vector of the j^{th} webpage, and the advertisement implicit feature vector of the k^{th} advertisement. The probability of clicking the k^{th} advertisement may be determined according to the user implicit feature vector of the i^{th} user, the webpage implicit feature vector of the j^{th} webpage, and the advertisement implicit feature vector of the k^{th} advertisement.

Specifically, the user implicit feature vector of the i^{th} user, the webpage implicit feature vector of the j^{th} webpage, and the advertisement implicit feature vector of the k^{th} advertisement are obtained according to the foregoing three matrices by using the unified maximum posteriori probability as the target function and based on the gradient descent method. A first vector, a second vector, and a third vector may be separately determined according to the user implicit feature vector of the i^{th} user, the webpage implicit feature vector of the j^{th} webpage, and the advertisement implicit feature vector of the k^{th} advertisement, where the first vector may represent a level of the i^{th} user's interest in the j^{th} webpage, the second vector may represent a level of the i^{th} user's interest in the k^{th} advertisement, and the third vector may represent a degree of an association between the j^{th} webpage and the k^{th} advertisement. A linear combination of the first vector, the second vector, and the third vector may be mapped into [0, 1], so as to obtain a probability of clicking the k^{th} advertisement when the i^{th} user visits the j^{th} webpage.

The k^{th} advertisement may be any advertisement in the x advertisements. For each advertisement, a probability of clicking the advertisement when the i^{th} user visits the j^{th} webpage may be calculated according to the foregoing process. In this way, the probabilities of clicking the x advertisements when the i^{th} user visits the j^{th} webpage may be obtained.

Currently, because a quantity of webpages and a quantity of users are relatively large, complexity of a recommendation algorithm is a factor that needs to be focused on. In this embodiment, an overhead of a calculation process mainly arises from the gradient descent method. Complexity of an algorithm increases linearly with a data volume in the three matrices. Therefore, this embodiment is applicable to large-scale data processing.

Optionally, in another embodiment, in step 130, for the k^{th} advertisement in the x advertisements, if the historical recommendation information indicates that the k^{th} advertisement has not been recommended to the i^{th} user, it may be determined that a novelty factor corresponding to the k^{th} advertisement is a first value; and if the historical recommendation information indicates that the k^{th} advertisement has been recommended to the i^{th} user before, it may be determined that the novelty factor corresponding to the k^{th} advertisement is a second value.

The first value is greater than the second value, and k is a positive integer ranging from 1 to x.

Specifically, the foregoing k^{th} advertisement may be any advertisement in the x advertisements. Each advertisement may be corresponding to a novelty factor. A novelty factor corresponding to each advertisement may be used to represent novelty of the advertisement for the i^{th} user. For each advertisement, the novelty factor in a case in which the advertisement has not been recommended to the i^{th} user is greater than the novelty factor in a case in which the advertisement has been recommended to the i^{th} user. A larger novelty factor corresponding to an advertisement indicates a higher novelty of the advertisement for the i^{th} user, which means that the i^{th} user is unfamiliar with the advertisement or has not seen the advertisement.

It may be learned that, in this embodiment, for each advertisement, the novelty factor in a case in which the advertisement has not been recommended to the i^{th} user is greater than the novelty factor in a case in which the advertisement has been recommended to the i^{th} user. In this way, novelty of a recommended advertisement can be improved, thereby improving user experience.

The first value and the second value may be preset, for example, the first value may be preset to 1, and the second value may be preset to 0.5. Alternatively, the second value may be obtained according to the historical recommendation information and an Ebbinghaus forgetting curve.

Optionally, in another embodiment, in step 130, it may be determined that the k^{th} advertisement was recommended to the i^{th} user q days ago, where q is a positive integer, an Ebbinghaus forgetting curve value that is corresponding to the q days is determined, and it is determined that the novelty factor corresponding to the k^{th} advertisement is a difference between the first value and the Ebbinghaus forgetting curve value.

For example, the first value may be preset to 1, and the second value may be preset to (1−the Ebbinghaus forgetting curve value).

For an advertisement that has been recommended to the i^{th} user, a novelty factor corresponding to the advertisement may be determined based on the Ebbinghaus forgetting curve. In this way, accuracy of a novelty factor can be improved, thereby improving novelty of an advertisement recommended to a user and improving user experience. It should be noted that, determining, based on the Ebbinghaus forgetting curve value, the novelty factor corresponding to the advertisement is merely a preferable implementation manner used in the present disclosure. It may be understood that, solutions of the present disclosure can also be implemented by using a weight correlated with q, instead of the Ebbinghaus forgetting curve value.

Optionally, in another embodiment, in step 130, for the k^{th} advertisement in the x advertisements, a similarity between the k^{th} advertisement and another advertisement in the x advertisements may be determined. A similarity ranking corresponding to the k^{th} advertisement and a dissimilarity ranking corresponding to the k^{th} advertisement may be determined in the x advertisements according to the similarity between the k^{th} advertisement and the another advertisement. Weighing may be performed on the similarity ranking corresponding to the k^{th} advertisement and the dissimilarity ranking corresponding to the k^{th} advertisement, to obtain a novelty factor corresponding to the k^{th} advertisement, where k is a positive integer ranging from 1 to x.

Specifically, novelty factors corresponding to advertisements may be determined according to intra-list similarity, an evaluation indicator of a field classification system. For the x advertisements, a similarity between two advertisements may be determined. For example, the similarity between two advertisements may be determined according to a cosine similarity algorithm or a Pearson similarity algorithm. In this way, for each advertisement, a similarity ranking RS and a dissimilarity ranking NRS that are corresponding to the advertisement may be determined in the x advertisements by using a similarity between the advertisement and another advertisement. Then, weighing may be performed on the similarity ranking and the dissimilarity ranking that are corresponding to the advertisement, to obtain a novelty factor corresponding to the advertisement. For example, the novelty factor of the advertisement=W*RS+(1−W)*NRS, where W is a weight.

In this embodiment, accuracy of a novelty factor can be improved, thereby improving novelty of an advertisement recommended to a user and improving user experience.

Optionally, in another embodiment, in step 130, for the k^{th} advertisement in the x advertisements, a diversity distance between the k^{th} advertisement and another advertisement in the x advertisements is determined; and a novelty factor corresponding to the k^{th} advertisement is determined according to the diversity distance between the k^{th} advertisement and the another advertisement, where k is a positive integer ranging from 1 to x.

Specifically, the novelty factor corresponding to each respective advertisement of the x advertisements may be determined based on a recommendation diversity principle. For the x advertisements, a diversity distance between two advertisements may be determined. For example, the diversity distance between two advertisements may be obtained based on a Jaccard diversity distance calculation manner.

Therefore, for each advertisement, a diversity distance between the advertisement and another advertisement may be obtained by means of calculation. A novelty factor corresponding to the advertisement is determined according to the diversity distance between the advertisement and the another advertisement. For example, summation may be performed on diversity distances between the advertisement and other advertisements to obtain the novelty factor corresponding to the advertisement. In this embodiment, accuracy of a novelty factor can be improved, thereby improving novelty of an advertisement recommended to a user and improving user experience.

Optionally, in another embodiment, in step 140, weighing may be performed on a clicking probability corresponding to each respective advertisement of the x advertisements and a novelty factor corresponding to each respective advertisement of the x advertisements, to determine scores corresponding to each respective advertisement of the x advertisements. The x advertisements may be sorted in descending order of the scores corresponding to the x advertisements, to obtain x sorted advertisements. The first p advertisements in the x sorted advertisements are determined as the p advertisements to be recommended to the i^{th} user.

Specifically, weighing may be performed, by using a weighing algorithm, on the clicking probabilities and the novelty factors, to obtain a score corresponding to each advertisement. For example, for each advertisement, corresponding weights may be allocated to a probability of clicking the advertisement and a novelty factor of the advertisement, and weighing may be performed, by using the allocated weights, on the probability of clicking the advertisement and the novelty factor of the advertisement, to obtain a score corresponding to the advertisement. The x advertisements may be sorted in descending order of the scores corresponding to the x advertisements, and the first p advertisements in the x sorted advertisements are used as advertisements to be recommended to the i^{th} user. It may be learned that, when an advertisement to be recommended to the i^{th} user is determined, both factors, that is, a clicking probability and a novelty factor are considered, so that a click-through rate of an advertisement can be improved and user experience can be improved.

Optionally, in another embodiment, in step 140, the x advertisements may be sorted in descending order of the clicking probabilities, to obtain x sorted advertisements. The first q advertisements in the x sorted advertisements may be sorted in descending order of the novelty factors, to obtain q re-sorted advertisements, where q is a positive integer and q is greater than p. The first p advertisements in the q re-sorted advertisements are determined as the p advertisements to be recommended to the i^{th} user.

For example, an advertisement recommendation list may be obtained based on the foregoing funnel-shaped filtering and weighing manner. Preferably, q is twice of p. It may be learned that, when an advertisement to be recommended to the i^{th} user is determined, both factors, that is, a clicking probability and a novelty factor are considered, so that a click-through rate of an advertisement can be improved and user experience can be improved.

Optionally, in another embodiment, in step 110, the webpage visit information and the advertisement click information may be acquired in real time from the user Internet visit log. The advertisement click information may include information about clicks on the recommended p advertisements by the user. That is, the information about clicks on the recommended p advertisements by the user is fed back in real time. In this way, a probability of clicking an advertisement can be adaptively adjusted with reference to real-time information, to further improve accuracy of predicting a probability of clicking an advertisement.

The following describes in detail a process of this embodiment of the present disclosure with reference to specific examples. It should be understood that, the following examples are merely intended to help a person skilled in the art better understand this embodiment of the present disclosure, instead of limiting the scope of this embodiment of the present disclosure.

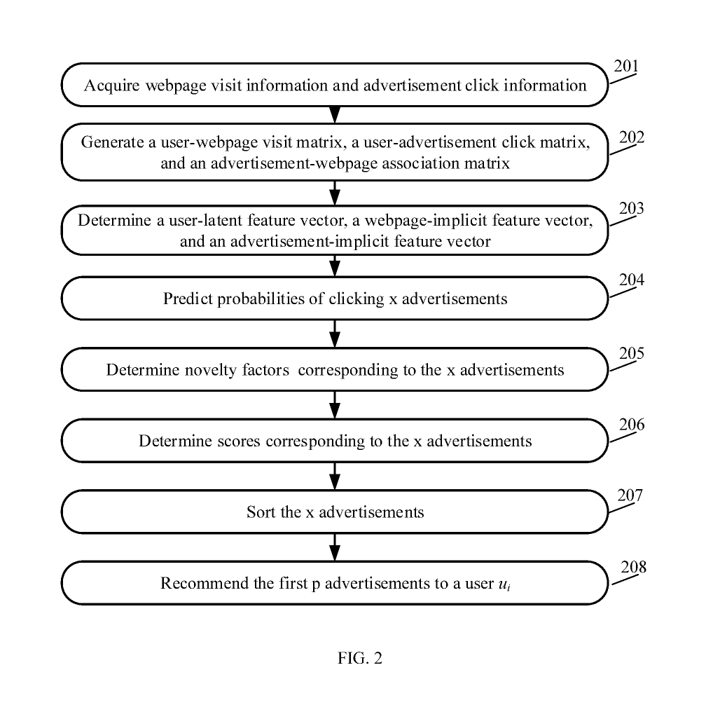

FIG. 2 is a schematic flowchart of a process of an advertisement recommendation method according to an embodiment of the present disclosure.

201. Acquire, from a user Internet visit log, webpage visit information and advertisement click information, where the webpage visit information is used to indicate n webpages visited by m users, the advertisement click information is used to indicate x advertisements clicked by the m users on the n webpages, and n, m and x are all positive integers greater than 1.

202. Generate, according to the webpage visit information and the advertisement click information, a user-webpage visit matrix, a user-advertisement click matrix, and an advertisement-webpage association matrix.

### (I) User-Webpage Visit Matrix

B may represent a user-webpage visit matrix. An element bᵢⱼ (bᵢⱼε[0,1]) in B represents a record of visits to a webpage wⱼ by a user uᵢ, and may also be considered as a level of interest of the user uᵢ in the webpage wⱼ. A larger quantity of times of browsing a webpage by a user may indicate a greater interest in content of this webpage. bᵢⱼ may be obtained by means of calculation by using formula (1):

bᵢⱼ=g(f(uᵢ,wⱼ)), (1)

where g(•) is a logistic function and used for normalization, and f (uᵢ, wⱼ) represents a quantity of times of browsing the webpage wⱼ by the user uᵢ.

### (II) User-Advertisement Click Matrix

C may represent a user-advertisement click matrix. An element cᵢₖ in C represents a level of interest of the user uᵢ in an advertisement aₖ. A user clicking an advertisement may indicate that the user is interested in the advertisement. cᵢₖ may be obtained by using formula (2):

cᵢₖ=g(f(uᵢ,aₖ)), (2)

where f (uᵢ, aₖ) represents a quantity of times of clicking the advertisement aₖ by the user uᵢ.

### (III) Advertisement-Webpage Association Matrix

R may represent an advertisement-webpage association matrix. An element rⱼₖ in R represents a degree of an association between the webpage wⱼ and the advertisement aₖ. When a same advertisement is displayed on different webpages, there are different click-through rates. A closer correlation between an advertisement and content of a webpage indicates a higher possibility of clicking the advertisement. Herein, the advertisement-webpage association matrix is determined with reference to a click-through rate of an advertisement when a webpage and an advertisement appear at the same time and a similarity between the webpage and the advertisement. In this way, accuracy of the advertisement-webpage association matrix can be improved.

rⱼₖ may be obtained by using formula (3):

rⱼₖ=adⱼₖ+(1−α)hⱼₖ, (3)

where dⱼₖ may represent a similarity between the webpage wⱼ and the advertisement aₖ, and hⱼₖ represents a click-through rate of the advertisement aₖ on the webpage wⱼ.

dⱼₖ may be obtained by using a probabilistic latent semantic analysis (PLSA) method or a latent Dirichlet allocation (LDA) algorithm.

hⱼₖ may be equal to a quantity of times of clicking the advertisement aₖ on the webpage wⱼ divided by a total quantity of times of posting the advertisement aₖ on the webpage wⱼ.

203. Determine, according to the user-webpage visit matrix, the user-advertisement click matrix, and the advertisement-webpage association matrix, a user implicit feature vector of a user uᵢ, a webpage implicit feature vector of a webpage wⱼ, and respective advertisement implicit feature vectors of the x advertisements.

Both a webpage visit history and an advertisement click history of a user can reflect an interest or a preference of the user. A click-through rate of an advertisement is closely correlated with an interest of the user and a degree of an association between an advertisement and a webpage. In this embodiment, the interest of the user is associated with the degree of an association between an advertisement and a webpage by using an AdRec model.

The following uses an advertisement aₖ in the x advertisements as an example for description. It should be understood that, the advertisement aₖ may be any advertisement in the x advertisements.

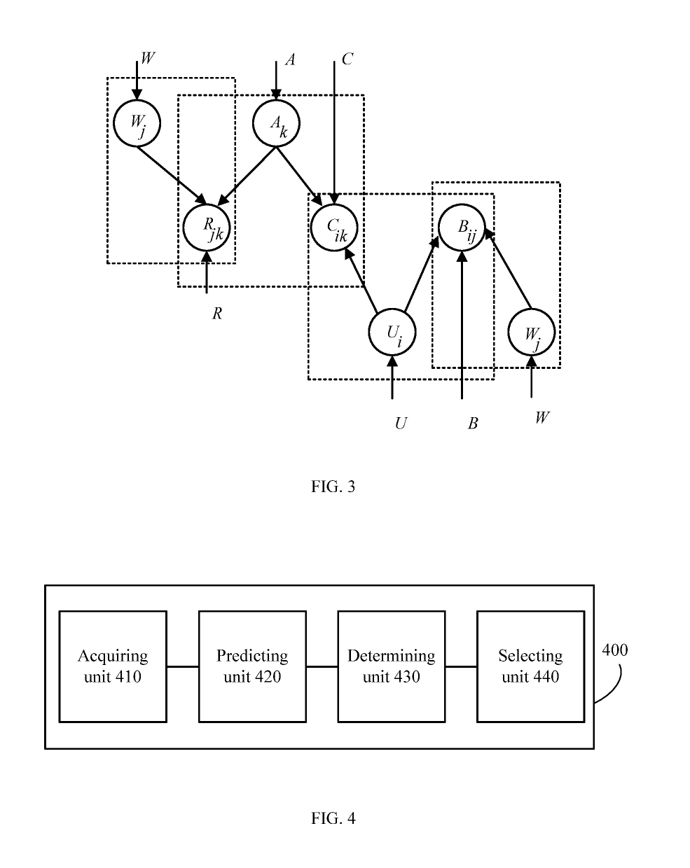

Specifically, the three latent feature vectors may be determined based on the AdRec model. FIG. 3 is a schematic diagram of an AdRec model according to an embodiment of the present disclosure. As shown in FIG. 3, the user-webpage visit matrix and the user-advertisement click matrix share a user implicit feature vector Uᵢ, and the user-advertisement click matrix and the advertisement-webpage association matrix share an advertisement implicit feature vector Aₖ.

The AdRec model is based on the following assumption:

(1) It is assumed that Uᵢ, Wⱼ, and Aₖ obey a normal distribution in an a priori manner and are independent of each other, that is:

$$\begin{matrix}p ( U \vert {σ}_{U}^{2} ) = {\prod }_{i = 1}^{m} N ( {U}_{i} \vert 0 , {σ}_{U}^{2} I ) & ( 4 ) \\ p ( W \vert {σ}_{W}^{2} ) = {\prod }_{i = 1}^{n} N ( {W}_{j} \vert 0 , {σ}_{W}^{2} I ) , \\ and & ( 5 ) \\ p ( A \vert {σ}_{A}^{2} ) = {\prod }_{k = 1}^{x} N ( {A}_{k} \vert 0 , {σ}_{A}^{2} I ) . & ( 6 )\end{matrix}$$

(II) After the user implicit feature vector of Uᵢ, the user uᵢ, and a webpage implicit feature vector Wⱼ (where both dimensions of Uᵢ, and Wⱼ are 1) of the webpage wⱼ are given, bᵢⱼ in accordance with a normal distribution in which an average value is g(Uᵢ^{T}Wⱼ) and a variance is σ_{B}², and values of bᵢⱼ are independent of each other. A conditional probability distribution of the user-webpage visit matrix B is as follows:

$$p ( B \vert U , W , {σ}_{B}^{2} ) = {\prod }_{i = 1}^{m} {\prod }_{j = 1}^{n} {[ N ( {b}_{ij} \vert g ( {U}_{i}^{T} {W}_{j} ) , {σ}_{B}^{2} ) ]}^{{I}_{ij}^{B}} , \qquad ( 7 )$$

where Iᵢⱼ^{B} is an indicator function, and g(•) is a logistic function.

When the user uᵢ has visited the webpage wⱼ, Iᵢⱼ^{B}=1; when the user uᵢ has not visited the webpage wⱼ, Iᵢⱼ^{B}=0.

A specific expressive form of g(•) is g(z)=1/(1+e^{-z}) and g(•) is used for mapping a value of Uᵢ^{T}Wⱼ to [0, 1]. Because a concept of probability is introduced to a UPMF algorithm, values of elements in the matrix should belong to [0, 1].

(III) cᵢₖ in accordance with a normal distribution in which an average value is g(Uᵢ^{T}Aₖ) and a variance is σ_{C}², and values of cᵢₖ are independent of each other. A conditional probability distribution of the user-advertisement click matrix C is as follows:

$$p ( C \vert U , A , {σ}_{c}^{2} ) = {\prod }_{i = 1}^{m} {\prod }_{k = 1}^{x} {[ N ( {c}_{ik} \vert g ( {U}_{i}^{T} {A}_{k} ) , {σ}_{C}^{2} ) ]}^{{I}_{ik}^{C}} , \qquad ( 8 )$$

where Iᵢₖ^{C} is an indicator function, and g(•) is a logistic function.

When the user uᵢ has clicked the advertisement aₖ, Iᵢₖ^{C}=1; when the user Iᵢₖ^{C}=0 has not clicked the advertisement aₖ, Iᵢₖ^{C}=0.

A specific form of g(•) is described in the foregoing and g(•) is used for mapping a value of Uᵢ^{T}Aₖ to [0, 1].

### IV

rⱼₖ in accordance with a normal distribution in which an average value is g(Wⱼ^{T}Aₖ) and a variance is σ_{R}², and values of rⱼₖ are independent of each other. A conditional probability distribution of the advertisement-webpage association matrix R is as follows:

$$p ( R \vert W , A , {σ}_{R}^{2} ) = {\prod }_{j = 1}^{n} {\prod }_{k = 1}^{x} {[ N ( {r}_{jk} \vert g ( {W}_{j}^{T} {A}_{k} ) , {σ}_{R}^{2} ) ]}^{{I}_{ik}^{C}} , \qquad ( 9 )$$

where Iᵢₖ^{R} is an indicator function, and g(•) is a logistic function.

When the webpage wⱼ is associated with the advertisement aₖ, that is, when rᵢₖ is greater than 0, Iᵢₖ^{R}=1; when the webpage wⱼ is not associated with the advertisement aₖ, Iᵢₖ^{R}=0.

A specific form of g(•) is described in the foregoing and g(•) is used for mapping a value of Uᵢ^{T}Aₖ to [0, 1].

### V

A posteriori distribution function of U, W, and A may be derived according to the foregoing equations (4) to (9). A log function of the a posteriori distribution function is as follows:

$$ln p ( U , W , A \vert B , C , R , {σ}_{A}^{2} , {σ}_{W}^{2} , {σ}_{U}^{2} , {σ}_{R}^{2} , {σ}_{B}^{2} , {σ}_{C}^{2} ) = - \frac{1}{2 {σ}_{B}^{2}} {\sum }_{i = 1}^{m} {\sum }_{j = 1}^{n} {{I}_{ij}^{B} ( {b}_{ij} - g ( {U}_{i}^{T} {W}_{j} ) )}^{2} - \frac{1}{2 {σ}_{C}^{2}} {\sum }_{i = 1}^{m} {\sum }_{k = 1}^{x} {{I}_{ik}^{C} ( {c}_{ik} - g ( {U}_{i}^{T} {A}_{k} ) )}^{2} - \frac{1}{2 {σ}_{R}^{2}} {\sum }_{j = 1}^{n} {\sum }_{k = 1}^{x} {{I}_{ik}^{C} ( {r}_{jk} - g ( {W}_{j}^{T} {A}_{k} ) )}^{2} - \frac{1}{2 {σ}_{U}^{2}} {\sum }_{i = 1}^{m} {U}_{i}^{T} {U}_{i} - \frac{1}{2 {σ}_{W}^{2}} {\sum }_{j = 1}^{n} {W}_{j}^{T} {W}_{j} - \frac{1}{2 {σ}_{A}^{2}} {\sum }_{k = 1}^{x} {A}_{k}^{T} {A}_{k} - {\sum }_{i = 1}^{m} {\sum }_{j = 1}^{n} {I}_{ij}^{B} ln {σ}_{B} - {\sum }_{i = 1}^{m} {\sum }_{k = 1}^{x} {I}_{ik}^{C} ln {σ}_{C} - {\sum }_{j = 1}^{n} {\sum }_{k = 1}^{x} {I}_{ik}^{R} ln {σ}_{R} - l \cdot {\sum }_{i = 1}^{m} ln {σ}_{U} - l \cdot {\sum }_{j = 1}^{n} ln {σ}_{W} - l \cdot {\sum }_{k = 1}^{x} ln {σ}_{A} + T \qquad ( 10 )$$

T is a constant. Equation (10) may be considered as an unconstrained optimization. Equation (11) is equivalent to equation (10).

$$E ( U , W , A , B , C , R ) = \frac{1}{2} {\sum }_{i = 1}^{m} {\sum }_{j = 1}^{n} {{I}_{ij}^{B} ( {b}_{ij} - g ( {U}_{i}^{T} {W}_{j} ) )}^{2} + \frac{{θ}_{C}}{2} {\sum }_{i = 1}^{m} {\sum }_{k = 1}^{x} {{I}_{ik}^{C} ( {c}_{ik} - g ( {U}_{i}^{T} {A}_{k} ) )}^{2} + \frac{{θ}_{C}}{2} {\sum }_{j = 1}^{n} {\sum }_{k = 1}^{x} {{I}_{ik}^{R} ( {r}_{jk} - g ( {W}_{j}^{T} {A}_{k} ) )}^{2} + \frac{{θ}_{U}}{2} {\sum }_{i = 1}^{m} {U}_{i}^{T} {U}_{i} + \frac{{θ}_{W}}{2} {\sum }_{j = 1}^{n} {W}_{j}^{T} {W}_{j} - \frac{{θ}_{A}}{2} {\sum }_{k = 1}^{x} {A}_{k}^{T} {A}_{k} \\ where \\ {θ}_{C} = \frac{{σ}_{B}^{2}}{{σ}_{C}^{2}} , \\ {θ}_{R} = \frac{{σ}_{B}^{2}}{{σ}_{R}^{2}} , \\ {θ}_{U} = \frac{{σ}_{B}^{2}}{{σ}_{U}^{2}} , \\ {θ}_{W} = \frac{{σ}_{B}^{2}}{{σ}_{W}^{2}} , \\ and \\ {θ}_{A} = \frac{{σ}_{B}^{2}}{{σ}_{A}^{2}} . , \qquad ( 11 )$$

A local minimizer of equation (11) may be obtained based on a gradient descent method. Gradient descent formulas of Uᵢ, Wⱼ, and Aₖ are as follows:

$$\begin{matrix}\frac{\partial E}{\partial {U}_{i}} = {\sum }_{j = 1}^{n} {I}_{ij}^{B} ( g ( {U}_{i}^{T} {W}_{j} ) - {b}_{ij} ) {g}^{′} ( {U}_{i}^{T} {W}_{j} ) {W}_{j} + {θ}_{C} {\sum }_{k = 1}^{x} {I}_{ik}^{C} ( g ( {U}_{i}^{T} {A}_{k} ) - {c}_{ik} ) {g}^{′} ( {U}_{i}^{T} {A}_{k} ) {A}_{k} + {θ}_{U} {U}_{i} , & ( 12 ) \\ \frac{\partial E}{\partial {W}_{j}} = {\sum }_{i = 1}^{m} {I}_{ij}^{B} ( g ( {U}_{i}^{T} {W}_{j} ) - {b}_{ij} ) {g}^{′} ( {U}_{i}^{T} {W}_{j} ) {U}_{i} + {θ}_{R} {\sum }_{k = 1}^{x} {I}_{jk}^{R} ( g ( {W}_{j}^{T} {A}_{k} ) - {r}_{jk} ) {g}^{′} ( {W}_{j}^{T} {A}_{k} ) {A}_{k} + {θ}_{W} {W}_{j} , \\ and & ( 13 ) \\ \frac{\partial E}{\partial {A}_{k}} = {\sum }_{i = 1}^{m} {I}_{ik}^{C} ( g ( {U}_{i}^{T} {A}_{k} ) - {c}_{ik} ) {g}^{′} ( {U}_{i}^{T} {A}_{k} ) {U}_{i} + {θ}_{D} {\sum }_{j = 1}^{n} {I}_{jk}^{R} ( g ( {W}_{j}^{T} {A}_{k} ) - {r}_{jk} ) {g}^{′} ( {W}_{j}^{T} {A}_{k} ) {W}_{j} + {θ}_{A} {A}_{j} & ( 14 )\end{matrix}$$

Uᵢ, Wⱼ, and Aₖ may be obtained according to the foregoing formulas (12) to (14).

### (VI) Time Complexity Analysis

A computational overhead of the gradient descent method mainly arises from a target function E and a corresponding gradient descent formula. Because matrices B, C, and R are sparse matrices, time complexity of the target function in equation (10) may be O(n_{B}L+n_{C}l+n_{R}l), where n_{B}, n_{C}, and n_{R} respectively represent quantities of non-zero elements in the matrix B, the matrix C, and the matrix R.

Similarly, the time complexity in equations (12) to (14) may be derived. Therefore, total time complexity of each iteration is O(n_{B}L+n_{C}l+n_{R}l), that is, algorithm time complexity increases linearly with a quantity of observation data in the three sparse matrices. Therefore, this embodiment of the present disclosure may be applied to processing of large-scale data.

An advertisement feature vector of each respective advertisement of the x advertisements may be obtained based on the foregoing process.

204. Predict, according to the user implicit feature vector of the user uᵢ, the webpage implicit feature vector of the webpage wⱼ, and the respective advertisement implicit feature vectors of the x advertisements, probabilities of clicking the x advertisements when the user uᵢ visits the webpage wⱼ.

The following still uses the advertisement aₖ as an example for description.

When the user uᵢ visits the webpage wⱼ, a probability of clicking the advertisement aₖ may be represented by using a real number yᵤ_{ᵢ}_{,w}_{ⱼ}_{,a}_{ₖ}, and may be obtained according to equation (15):

yᵤ_{ᵢ}_{,w}_{ⱼ}_{,a}_{ₖ}:=h(Uᵢ^{T}Wⱼ,Uᵢ^{T}Aₖ,Wⱼ^{T}Aₖ) (15)

where h(•) is a function whose parameters are Uᵢ^{T}Wⱼ, Uᵢ^{T}Aₖ, and Wⱼ^{T}Aₖ.

Uᵢ^{T}Wⱼ may represent a level of interest of the user uᵢ in the webpage Uᵢ^{T}Aₖ may represent a level of interest of the user uᵢ in the advertisement aₖ, and Wⱼ^{T}Aₖ may represent a degree of an association between the advertisement aₖ and the webpage wⱼ.

The probabilities of clicking the x advertisements when the user u visits the webpage wⱼ may be obtained according to equation (15).

205. Determine, according to historical recommendation information of the x advertisements, a novelty factor corresponding to each respective advertisement of the x advertisements.

The following still uses the advertisement aₖ as an example for description.

A novelty factor eₐ_{ₖ} corresponding to the advertisement aₖ may be determined according to equation (16):

$${e}_{a} \{ \begin{matrix}\begin{matrix}1 , if an advertisement {a}_{k} has not been \\ recommended to a user {u}_{i}\end{matrix} \\ \begin{matrix}1 - an Ebbinghaus forgetting curve value , \\ if an advertisement {a}_{k} was recommended to a user \\ {u}_{i} q days ago\end{matrix}\end{matrix} , \qquad ( 16 )$$

where q is a positive integer. An Ebbinghaus forgetting curve value that is corresponding to q may be obtained based on a value of q.

In this way, a novelty factor corresponding to each respective advertisement of the x advertisements may be obtained according to equation (16).

206. Perform weighing on the probabilities of clicking the x advertisements and the novelty factor corresponding to each respective advertisement of the x advertisements, to obtain scores corresponding to each respective advertisement of the x advertisements.

For example, corresponding weights may be allocated to a probability of clicking each advertisement and a novelty factor of the advertisement, and weighing is performed, by using the allocated weights, on the probability of clicking the advertisement and the novelty factor of the advertisement, to obtain a score corresponding to the advertisement. The sum of a weight of the probability of clicking each advertisement and a weight of the novelty factor of the advertisement is 1.

207. Sort, in descending order of the scores corresponding to the x advertisements, the x advertisements to obtain x sorted advertisements.

208. Recommend, when the user uᵢ visits the webpage wⱼ, the first p advertisements in the x sorted advertisements to the user uᵢ, where p is a positive integer.

Specifically, information about the p advertisements may be presented on the webpage wⱼ when the user uᵢ visits the webpage wⱼ.

In addition, after the probabilities of clicking the x advertisements and the novelty factor corresponding to each respective advertisement of the x advertisements are obtained, the p advertisements to be recommended to the user uᵢ may be determined in another manner except step 206 and step 207. For example, the p advertisements to be recommended to the user uᵢ may be obtained based on a funnel-shaped filtering and weighing manner. Specifically, the x advertisements may be sorted in descending order of the clicking probabilities to obtain the x sorted advertisements; then, the first q advertisements in the x sorted advertisements may be re-sorted in descending order of the novelty factors to obtain q re-sorted advertisements; then, the first p advertisements in the q re-sorted advertisements may be recommended to the user uᵢ. q may be, for example, twice of p.

In this embodiment of the present disclosure, probabilities of clicking x advertisements when the i^{th} user visits the j^{th} webpage are predicted according to webpage visit information and advertisement click information, the novelty factor corresponding to each respective advertisement of the x advertisements are determined according to historical recommendation information, and p advertisements to be recommended to the i^{th} user are determined from the x advertisements according to the probabilities of clicking the x advertisements and the novelty factor corresponding to each respective advertisement of the x advertisements, where a degree of awareness of the i^{th} user about the p advertisements is lower than a degree of awareness of the i^{th} user about an advertisement other than the p advertisements, in the x advertisements, and a sum of probabilities of clicking the p advertisements are higher than a sum of probabilities of clicking an advertisement other than the p advertisements, in the x advertisements. Because a probability of clicking an advertisement is predicted by comprehensively considering information about a user, a webpage, and an advertisement, accuracy of predicting a probability of clicking an advertisement can be improved. In addition, because novelty of an advertisement is considered, recommending a same type of advertisement to a user in a long time without considering a potential interest of a user can be avoid. Therefore, a click-through rate of an advertisement can be improved, and user experience is further improved.

FIG. 4 is a schematic block diagram of an advertisement recommendation server according to an embodiment of the present disclosure. The advertisement recommendation server 400 in FIG. 4 includes an acquiring unit 410, a predicting unit 420, a determining unit 430, and a selecting unit 440.

The acquiring unit 410 acquires, from an Internet log of a user, webpage visit information and advertisement click information, where the webpage visit information is used to indicate n webpages visited by m users, the advertisement click information is used to indicate x advertisements clicked by the m users on the n webpages, and n, m and x are all positive integers greater than 1. The predicting unit 420 predicts, according to the webpage visit information and the advertisement click information, probabilities of clicking the x advertisements when the i^{th} user among the m users visits the i^{th} webpage, where i is a positive integer ranging from 1 to m, and j is a positive integer ranging from 1 to n. The determining unit 430 determines a novelty factor corresponding to each respective advertisement of the x advertisements, where a novelty factor corresponding to each respective advertisement of the x advertisements is used to represent a degree of awareness of the i^{th} user about the advertisement. The selecting unit 440 determines, from the x advertisements according to the probabilities of clicking the x advertisements and the novelty factor corresponding to each respective advertisement of the x advertisements, p advertisements to be recommended to the i^{th} user, where a degree of awareness of the i^{th} user about the p advertisements is lower than a degree of awareness of the i^{th} user about an advertisement other than the p advertisements, in the x advertisements, and a sum of probabilities of clicking the p advertisements are higher than a sum of probabilities of clicking an advertisement other than the p advertisements in the x advertisements, where p is a positive integer and p≦x.

In this embodiment of the present disclosure, probabilities of clicking x advertisements when the i^{th} user visits the j^{th} webpage are predicted according to webpage visit information and advertisement click information, the novelty factor corresponding to each respective advertisement of the x advertisements are determined according to historical recommendation information, and p advertisements to be recommended to the i^{th} user are determined from the x advertisements according to the probabilities of clicking the x advertisements and the novelty factor corresponding to each respective advertisement of the x advertisements, where a degree of awareness of the i^{th} user about the p advertisements is lower than a degree of awareness of the i^{th} user about an advertisement other than the p advertisements, in the x advertisements, and a sum of probabilities of clicking the p advertisements are higher than a sum of probabilities of clicking an advertisement other than the p advertisements in the x advertisements. Because a probability of clicking an advertisement is predicted by comprehensively considering information about a user, a webpage, and an advertisement, accuracy of predicting a probability of clicking an advertisement can be improved. In addition, because novelty of an advertisement is considered, recommending a same type of advertisement to a user in a long time without considering a potential interest of a user can be avoid. Therefore, a click-through rate of an advertisement can be improved, and user experience is further improved.

Optionally, in an embodiment, the determining unit 430 may determine, according to historical recommendation information, the novelty factor corresponding to each respective advertisement of the x advertisements, where the historical recommendation information is used to indicate a historical record of recommending the x advertisements separately to the i^{th} user.

Optionally, in another embodiment, for the k^{th} advertisement in the x advertisements, if the historical recommendation information indicates that the k^{th} advertisement has not been recommended to the i^{th} user, the determining unit 430 may determine that a novelty factor corresponding to the k^{th} advertisement is a first value; if the historical recommendation information indicates that the k^{th} advertisement has been recommended to the i^{th} user before, the determining unit 430 determines that a novelty factor corresponding to the k^{th} advertisement is a second value.

The first value is greater than the second value, and k is a positive integer ranging from 1 to x.

Optionally, in another embodiment, the determining unit 430 may determine that the k^{th} advertisement was recommended to the i^{th} user q days ago, where q is a positive integer. The determining unit 430 may determine an Ebbinghaus forgetting curve value that is corresponding to the q days. The determining unit 430 may determine that the novelty factor corresponding to the k^{th} advertisement is a difference between the first value and the Ebbinghaus forgetting curve value.

Optionally, in another embodiment, for the k^{th} advertisement in the x advertisements, the determining unit 430 may determine a similarity between the k^{th} advertisement and another advertisement in the x advertisements. The determining unit 430 may determine, in the x advertisements according to the similarity between the k^{th} advertisement and the another advertisement, a similarity ranking corresponding to the k^{th} advertisement and a dissimilarity ranking corresponding to the k^{th} advertisement. The determining unit 430 may perform weighing on the similarity ranking corresponding to the k^{th} advertisement and the dissimilarity ranking corresponding to the k^{th} advertisement, to obtain a novelty factor corresponding to the k^{th} advertisement. k is a positive integer ranging from 1 to x.

Optionally, in another embodiment, for the k^{th} advertisement in the x advertisements, the determining unit 430 may determine a diversity distance between the k^{th} advertisement and another advertisement in the x advertisements. The determining unit 430 may determine, according to the diversity distance between the k^{th} advertisement and the another advertisement, a novelty factor corresponding to the k^{th} advertisement. k is a positive integer ranging from 1 to x.

Optionally, in another embodiment, the selecting unit 440 may perform weighing on a clicking probability corresponding to each respective advertisement of the x advertisements and the novelty factor corresponding to each respective advertisement of the x advertisements, to determine scores corresponding to each respective advertisement of the x advertisements; and may sort, in descending order of the scores corresponding to the x advertisements, the x advertisements to obtain x sorted advertisements. Then, the selecting unit 440 may determine the first p advertisements in the x sorted advertisements as the p advertisements to be recommended to the i^{th} user.

Optionally, in another embodiment, the selecting unit 440 may sort, in descending order of the clicking probabilities, the x advertisements to obtain x sorted advertisements. The selecting unit 440 may sort, in descending order of the novelty factors, the first q advertisements in the x sorted advertisements to obtain q re-sorted advertisements, where q is a positive integer and q is greater than p. The selecting unit 440 may further determine the first p advertisements in the q re-sorted advertisements as the p advertisements to be recommended to the i^{th} user.

Optionally, in another embodiment, the predicting unit 420 may generate, according to the webpage visit information and the advertisement click information, a user-webpage visit matrix, a user-advertisement click matrix, and an advertisement-webpage association matrix, where an object in the i^{th} row and the j^{th} column of the user-webpage visit matrix represents a record of visits to the j^{th} webpage by the i^{th} user, an object in the i^{th} row and the k^{th} column of the user-advertisement click matrix represents a record of clicks on the k^{th} advertisement by the i^{th} user, and an object in the j^{th} row and the k^{th} column of the advertisement-webpage association matrix represents a degree of an association between the j^{th} webpage and the k^{th} advertisement, where k is a positive integer ranging from 1 to x. The predicting unit 420 may perform unified probabilistic matrix factorization on the user-webpage visit matrix, the user-advertisement click matrix, and the advertisement-webpage association matrix, to obtain a user implicit feature vector of the i^{th} user, a webpage implicit feature vector of the j^{th} webpage, and an advertisement implicit feature vector of the k^{th} advertisement. Then, the predicting unit 420 may determine, according to the user implicit feature vector of the i^{th} user, the webpage implicit feature vector of the j^{th} webpage, and the advertisement implicit feature vector of the k^{th} advertisement, a probability of clicking the k^{th} advertisement when the i^{th} user visits the j^{th} webpage.

For other functions and operations of the advertisement recommendation server 400 in FIG. 4, reference may be made to the process of the foregoing method embodiments in FIG. 1 to FIG. 3. To avoid repetition, details are not described herein again.

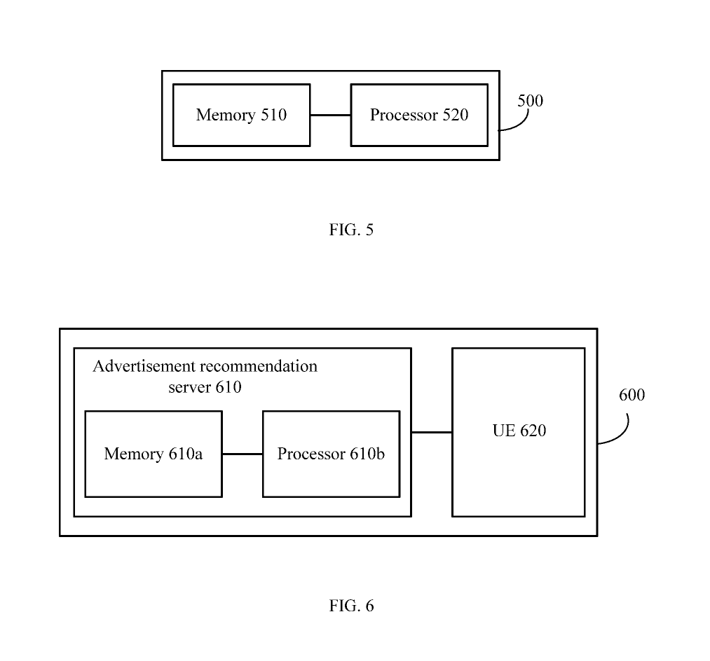

FIG. 5 is a schematic block diagram of an advertisement recommendation server according to an embodiment of the present disclosure. The advertisement recommendation server 500 in FIG. 5 may include a memory 510 and a processor 520.

The memory 510 may include a random access memory, a flash memory, a read-only memory, a programmable read-only memory, a non-volatile memory, a register, or the like. The processor 520 may be a central processing unit (CPU).

The memory 510 is configured to store an executable instruction. The processor 520 may perform the executable instruction stored in the memory 510, so as to: acquire, from a user Internet visit log, webpage visit information and advertisement click information, where the webpage visit information is used to indicate n webpages visited by m users, the advertisement click information is used to indicate x advertisements clicked by the m users on the n webpages, and n, m and x are all positive integers greater than 1; predict, according to the webpage visit information and the advertisement click information, probabilities of clicking the x advertisements when the i^{th} user among the m users visits the j^{th} webpage, where i is a positive integer ranging from 1 to m, and j is a positive integer ranging from 1 to n; determine a novelty factor corresponding to each respective advertisement of the x advertisements, where a novelty factor corresponding to each respective advertisement of the x advertisements is used to represent a degree of awareness of the i^{th} user about the advertisement; and determine, from the x advertisements according to the probabilities of clicking the x advertisements and the novelty factor corresponding to each respective advertisement of the x advertisements, p advertisements to be recommended to the i^{th} user, where a degree of awareness of the i^{th} user about the p advertisements is lower than a degree of awareness of the i^{th} user about an advertisement other than the p advertisements, in the x advertisements, and a sum of probabilities of clicking the p advertisements are higher than a sum of probabilities of clicking an advertisement other than the p advertisements in the x advertisements, where p is a positive integer and p≦x.

In this embodiment of the present disclosure, probabilities of clicking x advertisements when the i^{th} user visits the j^{th} webpage are predicted according to webpage visit information and advertisement click information, the novelty factor corresponding to each respective advertisement of the x advertisements are determined according to historical recommendation information, and p advertisements to be recommended to the i^{th} user are determined from the x advertisements according to the probabilities of clicking the x advertisements and the novelty factor corresponding to each respective advertisement of the x advertisements, where a degree of awareness of the i^{th} user about the p advertisements is lower than a degree of awareness of the i^{th} user about an advertisement other than the p advertisements, in the x advertisements, and a sum of probabilities of clicking the p advertisements are higher than a sum of probabilities of clicking an advertisement other than the p advertisements in the x advertisements. Because a probability of clicking an advertisement is predicted by comprehensively considering information about a user, a webpage, and an advertisement, accuracy of predicting a probability of clicking an advertisement can be improved. In addition, because novelty of an advertisement is considered, recommending a same type of advertisement to a user in a long time without considering a potential interest of the user can be avoided. Therefore, a click-through rate of an advertisement can be improved, and user experience is further improved.

Optionally, in an embodiment, the processor 520 may determine, according to historical recommendation information, the novelty factor corresponding to each respective advertisement of the x advertisements, where the historical recommendation information is used to indicate a historical record of recommending the x advertisements separately to the i^{th} user.

Optionally, in another embodiment, for the k^{th} advertisement in the x advertisements, if the historical recommendation information indicates that the k^{th} advertisement has not been recommended to the i^{th} user, the processor 520 may determine that a novelty factor corresponding to the k^{th} advertisement is a first value; and if the historical recommendation information indicates that the k^{th} advertisement has been recommended to the i^{th} user before, the processor 520 determines that a novelty factor corresponding to the k^{th} advertisement is a second value.

The first value is greater than the second value, and k is a positive integer ranging from 1 to x.

Optionally, in another embodiment, the processor 520 may determine that the k^{th} advertisement was recommended to the i^{th} user q days ago, where q is a positive integer. The processor 520 may determine an Ebbinghaus forgetting curve value that is corresponding to the q days. The processor 520 may determine that the novelty factor corresponding to the k^{th} advertisement is a difference between the first value and the Ebbinghaus forgetting curve value.

Optionally, in another embodiment, for the k^{th} advertisement in the x advertisements, the processor 520 may determine a similarity between the k^{th} advertisement and another advertisement in the x advertisements. The processor 520 may determine, in the x advertisements according to the similarity between the k^{th} advertisement and the another advertisement, a similarity ranking corresponding to the k^{th} advertisement and a dissimilarity ranking corresponding to the k^{th} advertisement. The processor 520 may perform weighing on the similarity ranking corresponding to the k^{th} advertisement and the dissimilarity ranking corresponding to the k^{th} advertisement, to obtain a novelty factor corresponding to the k^{th} advertisement. k is a positive integer ranging from 1 to x.

Optionally, in another embodiment, for the k^{th} advertisement in the x advertisements, the processor 520 may determine a diversity distance between the k^{th} advertisement and another advertisement in the x advertisements. The processor 520 may determine, according to the diversity distance between the k^{th} advertisement and the another advertisement, a novelty factor corresponding to the k^{th} advertisement. k is a positive integer ranging from 1 to x.

Optionally, in another embodiment, the processor 520 may perform weighing on a clicking probability corresponding to each respective advertisement of the x advertisements and the novelty factor corresponding to each respective advertisement of the x advertisements, to determine scores corresponding to each respective advertisement of the x advertisements; and may sort, in descending order of the scores corresponding to the x advertisements, the x advertisements to obtain x sorted advertisements. Then, the processor 520 may determine the first p advertisements in the x sorted advertisements as the p advertisements to be recommended to the i^{th} user.

Optionally, in another embodiment, the processor 520 may sort, in descending order of the clicking probabilities, the x advertisements to obtain x sorted advertisements. The processor 520 may sort, in descending order of the novelty factors, the first q advertisements in the x sorted advertisements, to obtain q re-sorted advertisements, where q is a positive integer and q is greater than p. The processor 520 may determine the first p advertisements in the q re-sorted advertisements as the p advertisements to be recommended to the i^{th} user.

Optionally, in another embodiment, the processor 520 may generate, according to the webpage visit information and the advertisement click information, a user-webpage visit matrix, a user-advertisement click matrix, and an advertisement-webpage association matrix, where an object in the i^{th} row and the j^{th} column of the user-webpage visit matrix represents a record of visits to the j^{th} webpage by the i^{th} user, an object in the i^{th} row and the k^{th} column of the user-advertisement click matrix represents a record of clicks on the k^{th} advertisement by the i^{th} user, and an object in the j^{th} row and the k^{th} column of the advertisement-webpage association matrix represents a degree of an association between the j^{th} webpage and the k^{th} advertisement, where k is a positive integer ranging from 1 to x. The processor 520 may perform unified probabilistic matrix factorization on the user-webpage visit matrix, the user-advertisement click matrix, and the advertisement-webpage association matrix, to obtain a user implicit feature vector of the i^{th} user, a webpage implicit feature vector of the j^{th} webpage, and an advertisement implicit feature vector of the k^{th} advertisement. Then, the processor 520 may determine, according to the user implicit feature vector of the i^{th} user, the webpage implicit feature vector of the j^{th} webpage, and the advertisement implicit feature vector of the k^{th} advertisement, a probability of clicking the k^{th} advertisement when the i^{th} user visits the j^{th} webpage.

For other functions and operations of the advertisement recommendation server 500 in FIG. 5, reference may be made to the process of the foregoing method embodiments in FIG. 1 to FIG. 3. To avoid repetition, details are not described herein again.

FIG. 6 is a schematic block diagram of an advertisement recommendation system according to an embodiment of the present disclosure. The advertisement recommendation system 600 in FIG. 6 includes an advertisement recommendation server 610 and a user equipment (UE) 620.

The UE 620 may be various forms of terminals that can access the Internet, for example, a desktop computer, a tablet computer, or a mobile phone.

The advertisement recommendation server 610 may recommend an advertisement to the UE 620.

Specifically, the advertisement recommendation server 610 may include a memory 610a and a processor 610b.

The memory 610a is configured to store an executable instruction. The processor 610b may perform the executable instruction stored in the memory 610a, so as to: acquire, from a user Internet visit log, webpage visit information and advertisement click information, where the webpage visit information is used to indicate n webpages visited by m users, the advertisement click information is used to indicate x advertisements clicked by the m users on the n webpages, and n, m and x are all positive integers greater than 1; predict, according to the webpage visit information and the advertisement click information, probabilities of clicking the x advertisements when the i^{th} user among the m users visits the j^{th} webpage, where i is a positive integer ranging from 1 to m, and j is a positive integer ranging from 1 to n; determine a novelty factor corresponding to each respective advertisement of the x advertisements, where a novelty factor corresponding to each respective advertisement of the x advertisements is used to represent a degree of awareness of the i^{th} user about the advertisement; and determine, from the x advertisements according to the probabilities of clicking the x advertisements and the novelty factor corresponding to each respective advertisement of the x advertisements, p advertisements to be recommended to the i^{th} user, where a degree of awareness of the i^{th} user about the p advertisements is lower than a degree of awareness of the i^{th} user about an advertisement other than the p advertisements, in the x advertisements, and a sum of probabilities of clicking the p advertisements are higher than a sum of probabilities of clicking an advertisement other than the p advertisements in the x advertisements, where p is a positive integer and p≦x.

Optionally, in an embodiment, the processor 610b may determine, according to historical recommendation information, the novelty factor corresponding to each respective advertisement of the x advertisements, where the historical recommendation information is used to indicate a historical record of recommending the x advertisements separately to the i^{th} user.

Optionally, in an embodiment, for the k^{th} advertisement in the x advertisements, if the historical recommendation information indicates that the k^{th} advertisement has not been recommended to the i^{th} user, the processor 610b may determine that a novelty factor corresponding to the k^{th} advertisement is a first value; and if the historical recommendation information indicates that the k^{th} advertisement has been recommended to the i^{th} user before, the processor 610b determines that a novelty factor corresponding to the k^{th} advertisement is a second value.

The first value is greater than the second value, and k is a positive integer ranging from 1 to x.

Optionally, in another embodiment, the processor 610b may determine that the k^{th} advertisement was recommended to the i^{th} user q days ago, where q is a positive integer. The processor 610b may determine an Ebbinghaus forgetting curve value that is corresponding to the q days. The processor 610b may determine that the novelty factor corresponding to the k^{th} advertisement is a difference between the first value and the Ebbinghaus forgetting curve value.

Optionally, in another embodiment, for the k^{th} advertisement in the x advertisements, the processor 610b may determine a similarity between the k^{th} advertisement and another advertisement in the x advertisements. The processor 610b may determine, in the x advertisements according to the similarity between the k^{th} advertisement and the another advertisement, a similarity ranking corresponding to the k^{th} advertisement and a dissimilarity ranking corresponding to the k^{th} advertisement. The processor 610b may perform weighing on the similarity ranking corresponding to the k^{th} advertisement and the dissimilarity ranking corresponding to the k^{th} advertisement, to obtain a novelty factor corresponding to the k^{th} advertisement. k is a positive integer ranging from 1 to x.

Optionally, in another embodiment, for the k^{th} advertisement in the x advertisements, the processor 610b may determine a diversity distance between the k^{th} advertisement and another advertisement in the x advertisements. The processor 610b may determine, according to the diversity distance between the k^{th} advertisement and the another advertisement, a novelty factor corresponding to the k^{th} advertisement. k is a positive integer ranging from 1 to x.

Optionally, in another embodiment, the processor 610b may perform weighing on a clicking probability corresponding to each respective advertisement of the x advertisements and the novelty factor corresponding to each respective advertisement of the x advertisements, to determine scores corresponding to each respective advertisement of the x advertisements; and may sort, in descending order of the scores corresponding to the x advertisements, the x advertisements to obtain x sorted advertisements. Then, the processor 610b may determine the first p advertisements in the x sorted advertisements as the p advertisements to be recommended to the i^{th} user.

Optionally, in another embodiment, the processor 610b may sort, in descending order of the clicking probabilities, the x advertisements to obtain x sorted advertisements. The processor 610b may sort, in descending order of the novelty factors, the first q advertisements in the x sorted advertisements, to obtain q re-sorted advertisements, where q is a positive integer and q is greater than p. The processor 610b may determine the first p advertisements in the q re-sorted advertisements as the p advertisements to be recommended to the i^{th} user.

Optionally, in another embodiment, the processor 610b may generate, according to the webpage visit information and the advertisement click information, a user-webpage visit matrix, a user-advertisement click matrix, and an advertisement-webpage association matrix, where an object in the i^{th} row and the j^{th} column of the user-webpage visit matrix represents a record of visits to the j^{th} webpage by the i^{th} user, an object in the i^{th} row and the k^{th} column of the user-advertisement click matrix represents a record of clicks on the k^{th} advertisement by the i^{th} user, and an object in the j^{th} row and the k^{th} column of the advertisement-webpage association matrix represents a degree of an association between the j^{th} webpage and the k^{th} advertisement, where k is a positive integer ranging from 1 to x. The processor 610b may perform unified probabilistic matrix factorization on the user-webpage visit matrix, the user-advertisement click matrix, and the advertisement-webpage association matrix, to obtain a user implicit feature vector of the i^{th} user, a webpage implicit feature vector of the j^{th} webpage, and an advertisement implicit feature vector of the k^{th} advertisement. Then, the processor 610b may determine, according to the user implicit feature vector of the i^{th} user, the webpage implicit feature vector of the j^{th} webpage, and the advertisement implicit feature vector of the k^{th} advertisement, a probability of clicking the k^{th} advertisement when the i^{th} user visits the j^{th} webpage.

In this embodiment of the present disclosure, probabilities of clicking x advertisements when the i^{th} user visits the j^{th} webpage are predicted according to webpage visit information and advertisement click information, a novelty factor corresponding to each respective advertisement of the x advertisements are determined according to historical recommendation information, and p advertisements to be recommended to the i^{th} user are determined from the x advertisements according to the probabilities of clicking the x advertisements and the novelty factor corresponding to each respective advertisement of the x advertisements, where a degree of awareness of the i^{th} user about the p advertisements is lower than a degree of awareness of the i^{th} user about an advertisement other than the p advertisements, in the x advertisements, and a sum of probabilities of clicking the p advertisements are higher than a sum of probabilities of clicking an advertisement other than the p advertisements in the x advertisements. Because a probability of clicking an advertisement is predicted by comprehensively considering information about a user, a webpage, and an advertisement, accuracy of predicting a probability of clicking an advertisement can be improved. In addition, because novelty of an advertisement is considered, recommending a same type of advertisement to a user in a long time without considering a potential interest of the user can be avoided. Therefore, a click-through rate of an advertisement can be improved, and user experience is further improved.

For other functions and operations of the advertisement recommendation server 610, reference may be made to the process of the foregoing method embodiments in FIG. 1 to FIG. 3. To avoid repetition, details are not described herein again.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of the present disclosure. The foregoing storage medium includes: any medium that can store program code, such as a Universal Serial Bus (USB) flash drive, a removable hard disk, a read-only memory (ROM), a random-access memory (RAM), a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. An advertisement recommendation method, comprising:
acquiring, from a user Internet visit log, webpage visit information and advertisement click information, wherein the webpage visit information indicates n webpages visited by m users, wherein the advertisement click information indicates x advertisements clicked by the users on the webpages, and wherein n, m, and x are integers greater than 1;
predicting, according to the webpage visit information and the advertisement click information, probabilities of clicking the x advertisements when an ith user among the users visits a jth webpage, wherein i is a positive integer from 1 to m, and wherein j is a positive integer from 1 to n;
determining a novelty factor corresponding to each respective advertisement of the x advertisements and representing a degree of awareness of the ith user about the respective advertisement; and
determining, from the x advertisements and according to the probabilities and the novelty factor, p advertisements to be recommended to the ith user,
wherein a degree of awareness of the ith user about the p advertisements is lower than a degree of awareness of the ith user about a second advertisement other than the p advertisements,
wherein a first sum of probabilities of clicking the p advertisements is higher than a second sum of probabilities of clicking n second advertisement, and
wherein p is a positive integer less than or equal to x.

2. The method of claim 1, wherein the determining the novelty factor comprises determining, the novelty factor according to historical recommendation information indicating a historical record of recommending the respective advertisement to the ith user.

3. The method of claim 2, wherein the determining the novelty factor further comprises:
setting a k^{th} novelty factor corresponding to a k^{th} advertisement to a first value when the historical recommendation information indicates that the k^{th} advertisement has not been recommended to the ith user, wherein k is an integer from 1 to x; and
setting the k^{th} novelty factor to a second value when the historical recommendation information indicates that the k^{th} advertisement has been recommended to the ith user before.

4. The method of claim 3, wherein the determining the novelty factor further comprises:
determining an Ebbinghaus forgetting curve value corresponding to q days when the k^{th} advertisement was recommended to the ith user q days ago, wherein the novelty factor is a difference between the first value and the Ebbinghaus forgetting curve value, and wherein q is a positive integer; and
determining that the novelty factor is the second value.

5. The method of claim 1, wherein the determining the novelty factor comprises:
determining a similarity between the k^{th} advertisement and a third advertisement in the x advertisements;
determining, in the x advertisements and according to the similarity, a similarity ranking corresponding to a k^{th} advertisement and a dissimilarity ranking corresponding to the k^{th} advertisement, wherein k is an integer ranging from 1 to x; and
weighing the similarity ranking and the dissimilarity ranking to obtain the novelty factor corresponding to the k^{th} advertisement.

6. The method of claim 1, wherein the determining the novelty factor comprises:
determining a diversity distance between the k^{th} advertisement and a third advertisement in the x advertisements, wherein k is an integer ranging from 1 to x; and
determining, according to the diversity distance, a novelty factor corresponding to the k^{th} advertisement.

7. The method of claim 1, wherein the determining the p advertisements comprises:
weighing a clicking probability corresponding to the respective advertisement and the novelty factor to determine scores corresponding to the respective advertisement;
sorting, in descending order of the scores, the x advertisements to obtain x sorted advertisements, wherein the first p advertisements in the x sorted advertisements are the p advertisements to be recommended to the ith user.

8. The method of claim 1, wherein the determining the p advertisements comprises:
sorting, in descending order of the probabilities, the x advertisements to obtain x sorted advertisements;
re-sorting, in descending order of the novelty factors, the first q advertisements in the x sorted advertisements to obtain q re-sorted advertisements, wherein q is a positive integer greater than p, and wherein the first p advertisements in the q re-sorted advertisements are the p advertisements to be recommended to the ith user.

9. The method of claim 1, wherein the predicting the probabilities comprises:
generating, according to the webpage visit information and the advertisement click information, a user webpage visit matrix, a user advertisement click matrix, and an advertisement webpage association matrix, wherein an object in the ith row and the jth column of the user webpage visit matrix represents a record of visits to the jth webpage by the ith user, an object in the ith row and the k^{th} column of the user advertisement click matrix represents a record of clicks on the k^{th} advertisement by the ith user, and an object in the jth row and the k^{th} column of the advertisement webpage association matrix represents a degree of an association between the jth webpage and the k^{th} advertisement, wherein k is a positive integer from 1 to x;
performing unified probabilistic matrix factorization on the user webpage visit matrix, the user advertisement click matrix, and the advertisement webpage association matrix to obtain a user implicit feature vector of the ith user, a webpage implicit feature vector of the jth webpage, and an advertisement implicit feature vector of the k^{th} advertisement; and
determining, according to the user implicit feature vector of the ith user, the webpage implicit feature vector of the jth webpage, and the advertisement implicit feature vector of the k^{th} advertisement, a probability of clicking the k^{th} advertisement when the ith user visits the jth webpage.

10. An advertisement recommendation server comprising:
a memory; and
a processor coupled to the memory and configured to:
acquire, from a user Internet visit log, webpage visit information and advertisement click information, wherein the webpage visit information indicates n webpages visited by m users, wherein the advertisement click information indicates x advertisements clicked by the users on the webpages, and wherein n, m and x are positive integers greater than 1;
predict, according to the webpage visit information and the advertisement click information, probabilities of clicking the x advertisements when an ith user among the users visits a jth webpage, wherein i is a positive integer from 1 to m, and wherein j is a positive integer from 1 to n;
determine a novelty factor corresponding to each respective advertisement of the x advertisements and representing a degree of awareness of the ith user about the respective advertisement; and
determine, from the x advertisements and according to the probabilities and the novelty factor, p advertisements to be recommended to the ith user,
wherein a degree of awareness of the ith user about the p advertisements is lower than a degree of awareness of the ith user about a second advertisement other than the p advertisements,
wherein a first sum of probabilities of clicking the p advertisements is higher than a second sum of probabilities of clicking a second advertisement, and
wherein p is a positive integer less than or equal to x.

11. The advertisement recommendation server of claim 10, wherein the processor is further configured to determine the novelty factor according to historical recommendation information indicating a historical record of recommending the respective advertisement to the ith user.

12. The advertisement recommendation server of claim 11, wherein the processor is further configured to:
set a k^{th} novelty factor corresponding to a k^{th} advertisement to a first value when the historical recommendation information indicates that the k^{th} advertisement has not been recommended to the ith user, wherein k is an integer from 1 to x; and
set the k^{th} novelty factor to a second value when the historical recommendation information indicates that the k^{th} advertisement has been recommended to the ith user before.

13. The advertisement recommendation server of claim 12, wherein the processor is further configured to determine an Ebbinghaus forgetting curve value correspond to q days when the k^{th} advertisement was recommended to the ith user q days ago, wherein the novelty factor is a difference between the first value and the Ebbinghaus forgetting curve value, and wherein q is a positive integer.

14. The advertisement recommendation server of claim 10, wherein the processor is further configured to:
determine a similarity between the k^{th} advertisement and a third advertisement in the x advertisements;
determine, in the x advertisements and according to the similarity, a similarity ranking corresponding to a k^{th} advertisement and a dissimilarity ranking corresponding to the k^{th} advertisement, wherein k is an integer between 1 and x; and
weight the similarity ranking and the dissimilarity ranking to obtain the novelty factor corresponding to the k^{th} advertisement.

15. The advertisement recommendation server of claim 10, wherein the processor is further configured to:
determine a diversity distance between the k^{th} advertisement and a third advertisement in the x advertisements; and
determine, according to the diversity distance, the novelty factor corresponding to the k^{th} advertisement.

16. The advertisement recommendation server of claim 10, wherein the processor is further configured to:
weight a clicking probability corresponding to the respective advertisement and the novelty factor to determine scores corresponding to the respective advertisement;
sort, in descending order of the scores, the x advertisements to obtain x sorted advertisements, wherein the first p advertisements in the x sorted advertisements are the p advertisements to be recommended to the ith user.

17. The advertisement recommendation server of claim 10, wherein the processor is further configured to:
sort, in descending order of the probabilities, the x advertisements to obtain x sorted advertisements;
re-sort, in descending order of the novelty factors, the first q advertisements in the x sorted advertisements to obtain q re-sorted advertisements, wherein q is a positive integer greater than p, and wherein the first p advertisements in the q re-sorted advertisements are the p advertisements to be recommended to the ith user.

18. The advertisement recommendation server of claim 10, wherein the processor is further configured to:
generate, according to the webpage visit information and the advertisement click information, a user webpage visit matrix, a user advertisement click matrix, and an advertisement webpage association matrix, wherein an object in the ith row and the jth column of the user webpage visit matrix represents a record of visits to the jth webpage by the ith user, an object in the ith row and the k^{th} column of the user advertisement click matrix represents a record of clicks on the k^{th} advertisement by the ith user, and an object in the jth row and the k^{th} column of the advertisement webpage association matrix represents a degree of an association between the jth webpage and the k^{th} advertisement, wherein k is a positive integer from 1 to x;
perform unified probabilistic matrix factorization on the user webpage visit matrix, the user advertisement click matrix, and the advertisement webpage association matrix to obtain a user implicit feature vector of the ith user, a webpage implicit feature vector of the jth webpage, and an advertisement implicit feature vector of the k^{th} advertisement; and
determine, according to the user implicit feature vector of the ith user, the webpage implicit feature vector of the jth webpage, and the advertisement implicit feature vector of the k^{th} advertisement, a probability of clicking the k^{th} advertisement when the ith user visits the jth webpage.
